(19) United States
(12) Patent Application Publication
(10) Pub. No.: US 2021/0262578 A1
(43) Pub. Date: Aug. 26, 2021

(54) VALVE TOP

(71) Applicant: Fluehs Drehtechnik GmbH, Luedenscheid (DE)

(72) Inventor: Lutz LANGE, Luedenscheid (DE)

(73) Assignee: Fluehs Drehtechnik GmbH, Luedenscheid (DE)

(21) Appl. No.: 17/253,735

(22) PCT Filed: Jun. 6, 2019
(86) PCT No.: PCT/EP2019/064842

§ 371 Date: Dec. 18, 2020

(30) Foreign Application Priority Data
Jul. 2, 2018 (EP) 18181236.3

(51) Int. Cl. F16K 11/074; F16K 3/08

(52) U.S. Cl. CPC F16K 11/0743; F16K 3/08

(57) ABSTRACT

A valve top, particularly for sanitary fittings, has a sleeve-like head piece which can be fastened in a valve housing of a fitting, through which head piece a spindle having a handle connection is passed centrally, which spindle is mounted for rotation around the longitudinal axis of same in the head piece and by which spindle a valve body can be actuated. At least one radially projecting extension is formed on the spindle within the head piece which can be rested with a side face against at least one stop arranged in the head piece, as a result of which the maximum angle of rotation of the spindle is restricted. A protrusion is formed on the side of the extension, which protrusion overlaps at least in parts this stop when the extension is resting on a stop of the head piece.

The invention relates to a valve upper part, in particular for sanitary fittings, having a sleeve-like head piece that can be attached in a valve housing of a fitting and through the center of which a spindle having a handle connector passes, which spindle is mounted in the head piece so as to rotate about its longitudinal axis and by way of which spindle a valve body can be activated, wherein at least one radially projecting extension is formed on the spindle, within the head piece, which extension can be laid, with a side surface, against at least one stop arranged in the head piece, whereby the maximum angle of rotation of the spindle is restricted.

Exit of media from fittings is controlled using valve upper parts. For this purpose, the valve upper part is screwed into the housing of a fitting by means of its head piece. A rotary handle or lever is attached to the handle connector of the spindle. In the case of known valve upper parts (cf. DE 32 07 895 C2), two disks are provided, in each instance, for controlling the through-flow. The disks are produced from a ceramic material. One of the two disks—control disk—is arranged in the valve upper part so as to rotate, with the aid of a driver that stands in connection with the spindle. The other disk—passage disk—is a fixed valve seat disk, also referred to as a fixed disk. When the control disk is rotated, the disks slide on one another. A seal is arranged on the side facing the valve seat of the fitting, which seal lies against the passage disk. The seal projects beyond the end face surface of the valve upper part. It serves for providing a seal not only for the passage disk but also toward the valve seat of the fitting.

The maximum angle of rotation of the spindle that is connected with the control disk with shape fit, by way of the driver, is limited by way of two stop surfaces that are formed on the inner wall of the head piece, against which an extension formed on the spindle can make contact. Usual maximum angles of rotation are 90° and 180°. In the case of a maximum angle of rotation of 180°, an extension that projects radially to one side is formed on the spindle. To limit a maximum angle of rotation of 90°, an extension that projects radially on two diametrically opposite sides can also be formed on the spindle, wherein accordingly, four stop surfaces are arranged on the inner wall of the head piece.

In the event of excessive torques that act on the spindle, as they occur, for example, in the case of hospital fittings having long operating handles for elbow activation, twisting of the spindle can come about, and thereby the extensions are forced in the direction of the control disk, with damage to the stop surface, and this can result in destruction of the valve upper part. This effect occurs, in particular, in the case of valve upper parts having small dimensions, in which the spindle and the stop surfaces are dimensioned to be correspondingly small.

This is where the invention seeks to provide a remedy. The invention is based on the task of making available a valve upper part in which damage is counteracted even in the case of excessive torques that act on the spindle. According to the invention, this task is accomplished by means of a valve upper part having the characteristics of the characterizing part of claim 1.

With the invention, a valve upper part is made available in which damage is prevented even in the case of high torques that act on the spindle. Because of the fact that a protrusion is formed on the extension, on the side, which protrusion covers a stop of the head piece, at least in certain regions, when the extension makes contact with this stop, the protrusion supports itself on the stop in the event that twisting of the spindle occurs, and thereby a movement of the extension in the direction of the control disk is prevented. In this regard, the lateral protrusion formed on the extension is arranged in such a manner that when the extension makes contact with the stop of the head piece, only a minimum distance is present between the protrusion and the stop.

In a further development of the invention, one or two arc-shaped ridges are formed on the inner mantle surface of the head piece, with a stop being formed by their end face surfaces, in each instance. As a result, a support surface that runs radially and circumferentially in certain regions is present, by means of which surface good support of a protrusion of the extension that projects beyond this support surface is made possible.

In an embodiment of the invention, the extension has a T-shaped cross-section, at least in certain regions, and thereby a protrusion is formed on both longitudinal sides. As a result, simple production of the protrusion is made possible. Due to the T-shaped cross-section, a lateral protrusion is formed, in each instance, for support on the two stops that limit the angle of rotation.

In a further development of the invention, the valve body is formed by a control disk that is arranged so as to rotate, which disk lies on an inlet disk arranged in torque-proof manner, wherein a disk is formed on the spindle, on its end side, and a driver is formed on this disk on the side facing away from the spindle, which driver engages into a recess of the control disk. In this regard, the driver is preferably formed on the disk that lies axially against a step formed in the head piece. By means of this arrangement, when the extension lies against a stop, this stop is surrounded by the disk on the one side and the lateral protrusion of the extension on the other side, and thereby twisting forces that act on the spindle and on the extension formed on it can be reliably conducted away. As a result, a downward movement of the extension if twisting of the spindle occurs is reliably counteracted.

Other further developments and embodiments of the invention are indicated in the remaining dependent claims. Exemplary embodiments of the invention are shown in the drawings and will be described in detail below. The figures show:

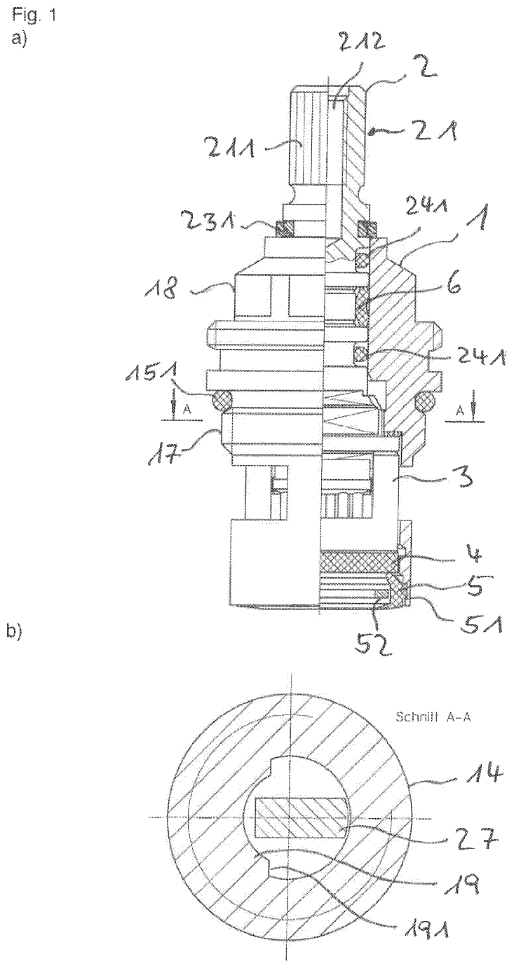

FIG. 1 the schematic representation of a valve upper part with the spindle in the center position
a) in partial section;
b) in cross-section A-A;

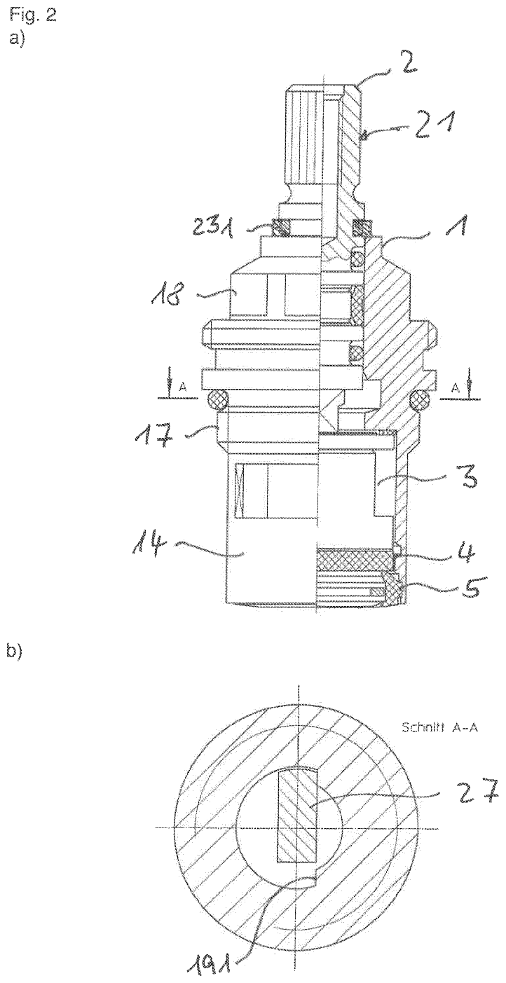

FIG. 2 the schematic representation of the valve upper part from FIG. 1 with the spindle in the stop position
a) in partial section;
b) in cross-section A-A;

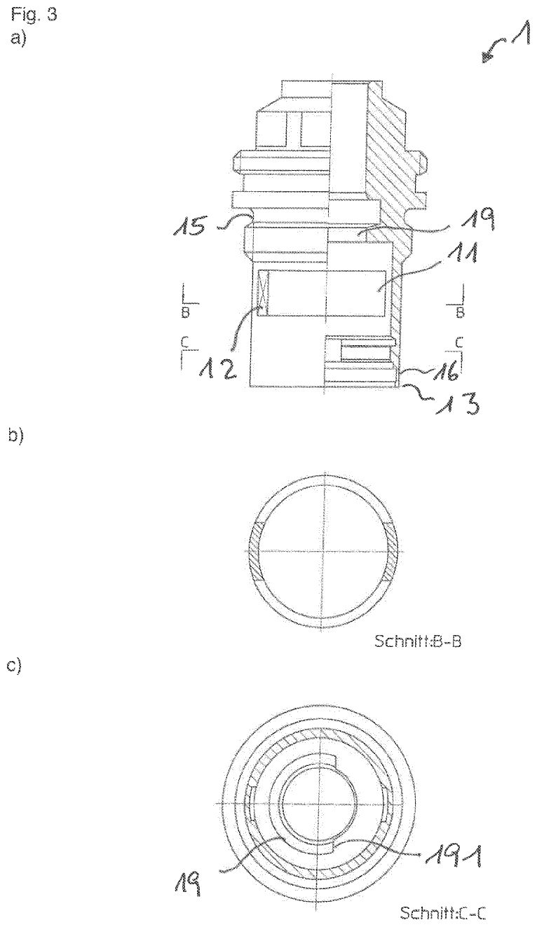

FIG. 3 the schematic representation of the head piece of the valve upper part from FIG. 1
a) in partial section;
b) in cross-section B-B;
c) in cross-section C-C;

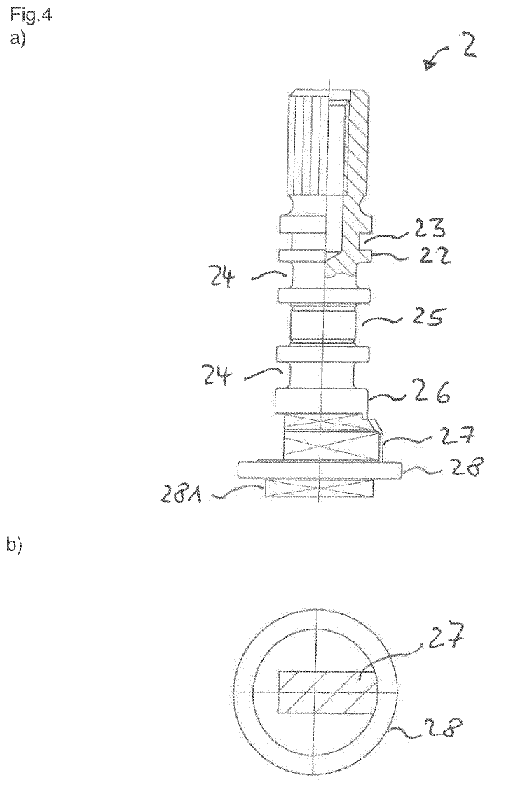

FIG. 4 the schematic representation of the spindle of the valve upper part from FIG. 1
a) in partial section;
b) in cross-section;

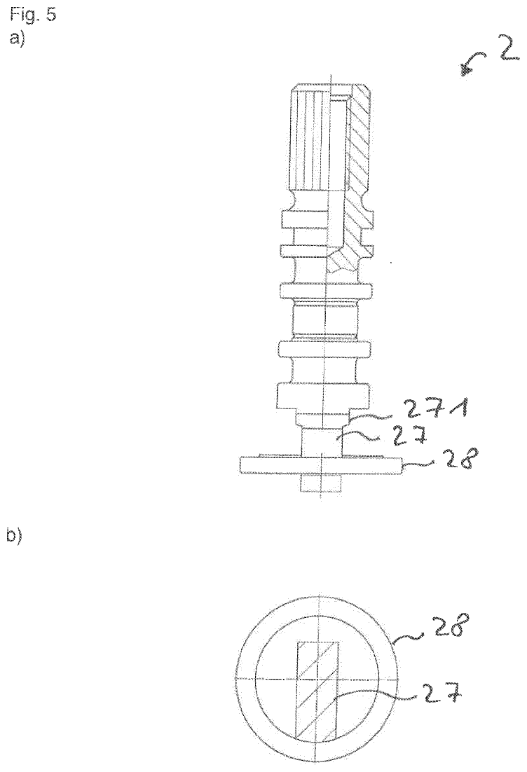

FIG. 5 the schematic representation of the spindle from FIG. 4 in a position rotated by 90°
a) in partial section;
b) in cross-section;

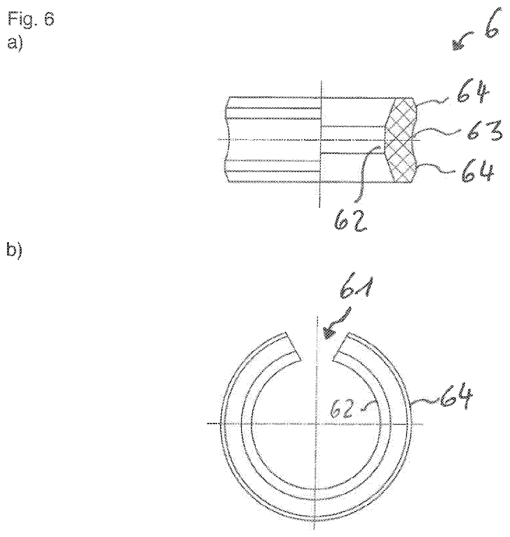

FIG. 6 the schematic representation of the slide sleeve of the valve upper part from FIG. 1
a) in partial section;
b) in a top view;

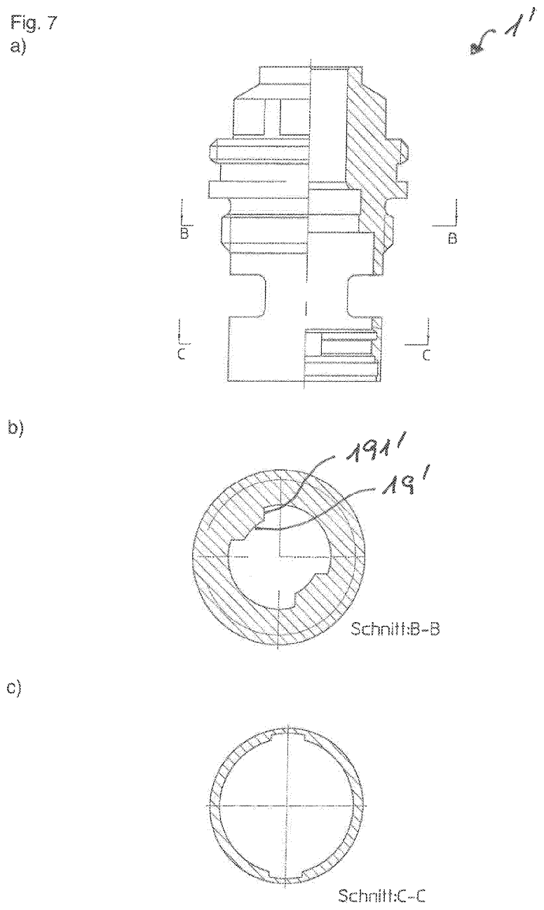

FIG. 7 the schematic representation of the head piece of a valve upper part in a further embodiment, with a pivot angle restricted to 90°
a) in partial section;
b) in cross-section B-B;
c) in cross-section C-C;

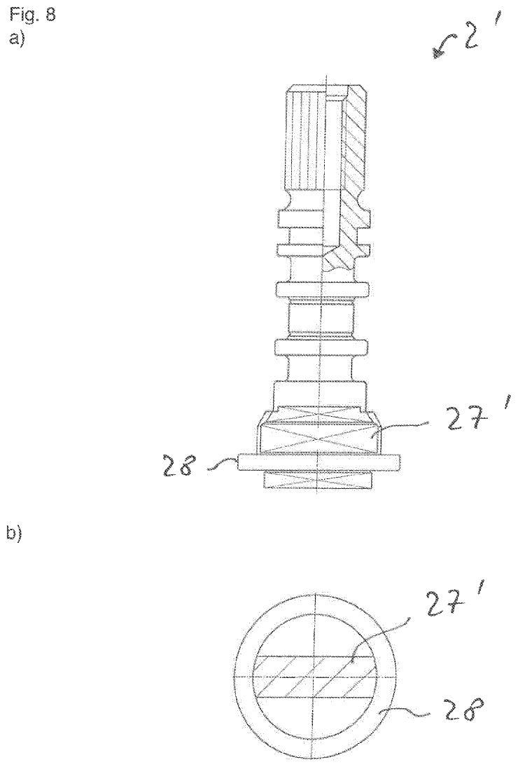

FIG. 8 the schematic representation of a spindle for use in the head piece from FIG. 7
a) in partial section;
b) in cross-section through the extension (top view);

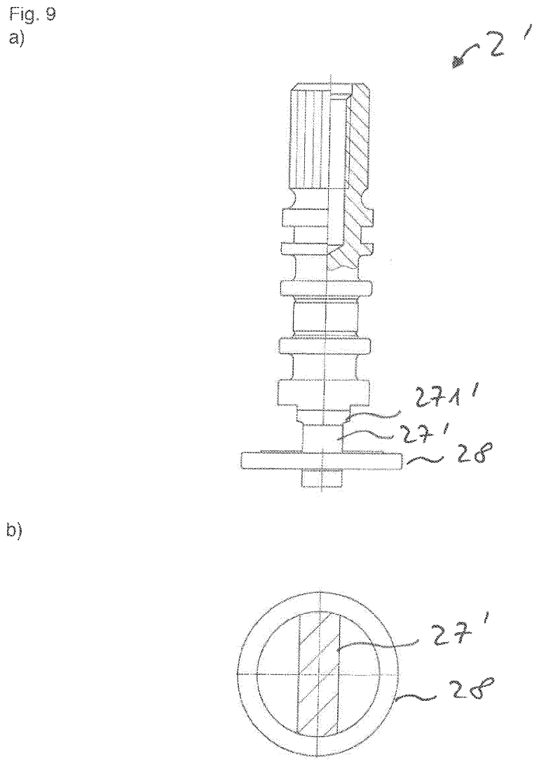

FIG. 9 the schematic representation of the spindle from FIG. 8, in a position rotated by 90°
a) in partial section;
b) in cross-section through the extension (top view).

The valve upper part selected as an exclusion example has a head piece 1, through the center of which a spindle 2, which is radially guided in it, passes. A control disk 3 is connected with the spindle 2 with shape fit and radially guided in the head piece 1. On the end of the control disk 3 that faces away from the spindle 1, an inlet disk 4 is provided in the head piece 1, followed by a lip seal 5 that makes contact with the valve seat of a fitting—not shown.

The head piece 1 is formed by a symmetrical hollow body that has two open end face surfaces. On its side facing the fitting—not shown—the head piece 1 has a sleeve-shaped part 14.

Passage windows 11 are provided in the sleeve-shaped part 14, which windows are delimited by longitudinal ridges 12. In the exemplary embodiment, two windows 11 delimited by longitudinal ridges 12 are provided. After the head piece 1 has been introduced into a fitting, a collar 13 of the head piece 1 lies on the housing of the fitting. The collar 13 has a ring groove 15 on its side facing the passage window 11 for holding an O-ring 151. An undercut 16 is arranged in the sleeve-shaped part 14, on the inside, in the region of the end that faces the valve seat. An outside thread 17 is formed on the head piece 1 on its end opposite to the passage window 11, followed by an external hex 18 for engagement of a screw tool.

The spindle 2 is structured to be essentially solid. On its end face that faces away from the water inflow, it is provided with a handle connector 21 that is structured, on the outside, as an external polygon 211 and provided with a dead-end hole 212 having an inside thread for attachment of a rotary handle—not shown. A cylindrical section 22 follows the handle connector 21, with which section the spindle 2 is radially guided in the head piece 1 and into which two ring grooves 24 for holding O-rings 241 are introduced, which O-rings seal the spindle 2 off with regard to the head piece 1. A further ring groove 25 for holding a slide bushing 6 is arranged between the ring grooves 24, each of which holds an O-ring 241. Furthermore, a recess 23 is provided between the handle connector 21 and the cylindrical section 22, into which recess a shaft retainer 231 in the form of a circlip is resiliently laid.

An extension 27 is axially formed on the cylindrical section 26, which extension has an essentially T-shaped cross-section and projects beyond the diameter of the cylindrical section 25 on one side. Because of the T-shaped cross-section of the extension 27, a protrusion 271 is formed on its side walls, in each instance. The extension 27 is configured in such a manner that it lies against a stop surface 191 of a stop 19 formed on the inner wall of the head piece 1 with a side surface, in each instance, at two defined pivot positions, wherein the protrusion 271 arranged on this side surface projects beyond the stop 19 at a slight axial distance. A disk 28 is formed on the extension 27, which disk has a driver 281 on its side facing the fitting—not shown. With its top that lies opposite the driver 281, the disk 28 lies against the underside, facing this disk 28, of the stop 19 of the head piece 1, which stop is configured in the form of an arc-shaped ridge.

The control disk 3 is configured as an essentially round disk, from which a circle cut-out has been removed. In the exemplary embodiment, the circle cut-out has an angle of approximately 180°. On its top, facing the spindle 2, the control disk 3 is furthermore provided with a holder for the driver 281 of the spindle 2.

A lip seal 5 is introduced into the head piece 1, adjacent to the inlet disk 4, which seal is provided with a ridge 51 on the outer circumference, which ridge engages into the undercut 16 provided for this purpose in the sleeve-shaped part 14 of the head piece 1, on the end side. The lip seal 5 is held in its position by way of a support ring 52 that has been introduced, wherein the lips of the lip seal 5 lie against the inlet disk 4 as well as against the fitting seat—not shown.

The slide bushing 6 is configured as a ring-shaped plastic body that is divided by a V-shaped slot 61 on one side. The inner mantle surface of the slide bushing 6 is configured to be essentially convex and has a first contact surface 62 that is arranged in the center and is circumferential. Opposite the first contact surface 62, the outer mantle surface of the slide bushing 6 has a concave curvature 63, and thereby two second contact surfaces 64, which are arranged parallel to one another and run circumferentially are delimited. In the assembled state, the slide bushing 6 lies against the groove base of the ring groove 25 of the spindle 2 with the first contact surface 62, wherein it lies against the inner mantle surface of the head piece 1 with its second contact surfaces 64, which are arranged offset from the first contact surface. (Alternatively, the slide bushing 6 can also have a centered second contact surface on its outer mantle surface, and two first contact surfaces, which run parallel to one another and are arranged offset from the inner second contact surface, on its inner mantle surface.) In this manner, an elastic and completely reversible slide bushing 6 is achieved between the spindle 2 and the head piece 1. By means of the V-shaped slot 61, the slide bushing 6 can be easily clipped onto the ring groove 25 of the spindle 2.

In FIGS. 7 and 8, the head piece and the spindle of a valve upper part are shown in a further embodiment, in which the control disk has a circle cut-out of approximately 90° and a maximum angle of rotation of the spindle of 90° is set up. For this purpose, the extension 27′, which again has a T-shaped cross-section, as a result of which a protrusion 271′ is formed, in each instance, is configured in such a manner that it projects beyond the diameter of the cylindrical section 25 of the spindle 2′ on two diametrically opposite sides. In this exemplary embodiment, two stops 19′ configured as arc-shaped ridges are arranged opposite one another within the head piece 1, and a side surface of the extension 27′ lies against the stop surfaces 191′ of the stops, in a contact position of the spindle 2′, on the end side, in each instance. In this regard, once again the protrusion 271′, arranged on the corresponding side surface, projects beyond the stop 19′, against which this side surface lies, with a slight distance. In this embodiment, the extension 27′ can consequently support itself on a stop 19′, in each instance, with two protrusions 271′, in every contact position of the spindle 2′.

1. A valve upper part, in particular for sanitary fittings, having a sleeve-like head piece (1) that can be attached in a valve housing of a fitting and through the center of which a spindle (2) having a handle connector passes, which spindle is mounted in the head piece (1) so as to rotate about its longitudinal axis and by way of which spindle a valve body can be activated, wherein at least one radially projecting extension (27) is formed on the spindle (2), within the head piece (1), which extension can be laid, with a side surface, against at least one stop (19) arranged in the head piece (1), whereby the maximum angle of rotation of the spindle (2) is restricted, wherein a protrusion (271) is formed on the extension (27), on the side, which protrusion covers the stop (19) of the head piece (1), at least in certain regions, when the extension (27) makes contact with this stop (19).

2. The valve upper part according to claim 1, wherein one or two arc-shaped stops (19) are formed on the inner mantle surface of the head piece (1), with a stop surface (191) being formed by their end face surfaces, in each instance.

3. The valve upper part according to claim 1, wherein the extension (27) has a T-shaped cross-section, at least in certain regions, and thereby a protrusion (271) is formed on both longitudinal sides.

4. The valve upper part according to claim 1, wherein the valve body is formed by a control disk (3) that is arranged so as to rotate, which disk lies on an inlet disk (4) arranged in torque-proof manner, wherein a disk (28) is formed on the spindle (2), on its end side, and a driver (281) is formed on this disk on the side facing away from the spindle (2), which driver engages into a recess of the control disk (3).

5. The valve upper part according to claim 4, wherein the driver (281) is formed on the disk, which disk lies axially against a step formed in the head piece (1).

6. The valve upper part according to claim 5, wherein the step is formed by at least one stop (19) formed on the inner mantle surface of the head piece (1).
